(19) United States
(12) Patent Application Publication
(10) Pub. No.: US 2015/0084921 A1
(43) Pub. Date: Mar. 26, 2015

(54) FLOATING TOUCH METHOD AND TOUCH DEVICE

(71) Applicant: Touchplus Information Corp., New Taipei City (TW)

(72) Inventor: SHIH-HSIEN HU, New Taipei City (TW)

(21) Appl. No.: 14/492,645

(22) Filed: Sep. 22, 2014

Related U.S. Application Data
(60) Provisional application No. 61/881,049, filed on Sep. 23, 2013.

(51) Int. Cl. G06F 3/044

(52) U.S. Cl. CPC G06F 3/044
USPC 345/174

(57) ABSTRACT

A floating touch method and a touch device are provided. The touch device includes a capacitive touch panel and a sensor circuit. At first, the sensor circuit controls the capacitive touch panel to sense a control object within different sensing ranges at different time points to determine a distance value between the control object and the capacitive touch panel. Then, the sensor circuit controls the capacitive touch panel to detect a floating touch action of the control object based on the distance value. Subsequently, the sensor circuit issues a control signal corresponding to the floating touch action to enable the touch device or the capacitive touch panel to perform a specific function.

### CROSS-REFERENCE TO RELATED APPLICATIONS

The present application is a nonprovisional application claiming benefit from a prior-filed provisional application bearing a Ser. No. 61/881,049 and filed Sep. 23, 2013, the entity of which is incorporated herein for reference.

### FIELD OF THE INVENTION

The present disclosure relates to a touch sensing method for a touch device, and particularly to a floating touch method and a touch device operated with the floating touch method.

### BACKGROUND OF THE INVENTION

With rapid development of touch sensing technology, many electronic apparatuses such as mobile phones, notebook computers or tablet computers take advantage of touch devices to provide intuitive operation and easy human-machine interface. These electronic apparatuses hugely enter modern lives and great business opportunities are created. There are two known touch sensing technologies, i.e. capacitive sensing and resistive sensing.

For capacitive sensing, when the touch device is touched with a human finger or a conductive object, a capacitor is temporarily formed on the electrode corresponding to the touched position. Therefore, equivalent capacitance of the corresponding electrode changes. A sensor circuit can determine the touched position on the touch device according to the equivalent capacitance change of the corresponding electrode.

For resistive sensing, when an object such a human finger or a stylus presses down onto a surface of the touch device, the upper electrode and the lower electrode are electrically connected at the pressed position so that the electrodes behave as a voltage divider circuit. Therefore, the sensor circuit can determine the pressed position on the touch device according to the voltage change of the upper electrode and the lower electrode.

Since large-area flat-panel display gains popularity now and touch sensing technology is widely used as the most friendly human-machine interface, there is an increased demand for large-area touch screen these days. For a large-area flat-panel display, optimum viewing distance increases. It does not make sense to control the display by actually touch a surface of the display with a finger or a conductive object instead of remote control. Therefore, a novel touch sensing method and touch device are desired.

### SUMMARY OF THE INVENTION

An aspect of the present disclosure provides a floating touch method used with a capacitive touch panel. At first, the capacitive touch panel is controlled to sense a control object within different sensing ranges at different time points to determine a distance value between the control object and the capacitive touch panel. Then, the capacitive touch panel is controlled to detect a floating touch action of the control object based on the distance value. Subsequently, a control signal corresponding to the floating touch action is issued.

In an embodiment, the capacitive touch panel includes many separate electrode units. To sense the control object, the electrode units are divided into first electrode unit groups which are detected individually to determine whether the control object is located within a first sensing range corresponding to the first electrode unit groups. Then, the electrode units are divided into second electrode unit groups which are detected individually to determine whether the control object is located within a second sensing range corresponding to the second electrode unit groups. The distance value is a distance threshold corresponding to a smaller sensing range of the first sensing range and the second sensing range if the control object is determined to be located within both the first sensing range and the second sensing range.

In an embodiment, each of the first electrode unit groups has a first number of the electrode units while each of the second electrode unit groups has a second number of the electrode units. The second number is greater than the first number, and the second sensing range is greater than the first sensing range.

In an embodiment, when the control object is determined to be located within the first sensing range, the distance value is the distance threshold corresponding to the first sensing range.

In an embodiment, an operation menu and a cursor are shown in response to a floating touch action of the control object. The floating touch action of the control object may be a hover action and the distance value determined during the hover action is recorded as a distance reference.

In an embodiment, the control signal is issued to make an icon of the operation menu deform when the cursor is controlled to stay on the icon and the control object moves toward the capacitive touch panel. If the determined distance value of the control object is smaller than a specific value or a specific proportion of the distance reference, a function corresponding to the icon is performed.

Another aspect of the present disclosure provides a touch device operated with a floating touch method. The touch device includes a capacitive touch panel and a sensor circuit electrically connected to the capacitive touch panel. The sensor circuit controls the capacitive touch panel to sense a control object within different sensing ranges at different time points to determine a distance value between the control object and the capacitive touch panel, controls the capacitive touch panel to detect a floating touch action of the control object based on the distance value, and issues a control signal corresponding to the floating touch action.

In an embodiment, the capacitive touch panel includes many separate electrode units and corresponding connecting traces. The capacitive touch panel further includes fractal electrode units disposed around edges of the separate electrode units.

In an embodiment, the sensor circuit divides the electrode units into first electrode unit groups which are detected individually to determine whether the control object is located within a first sensing range corresponding to the first electrode unit groups, divides the electrode units into a plurality of second electrode unit groups which are detected individually to determine whether the control object is located within a second sensing range corresponding to the second electrode unit groups, and determines the distance value to be a distance threshold corresponding to a smaller sensing range of the first sensing range and the second sensing range if the control object is determined to be located within both the first sensing range and the second sensing range.

In an embodiment, the sensor circuit shows an operation menu and a cursor on a display device.

In an embodiment, the floating touch action of the control object is a hover action and the distance value determined during the hover action is recorded as a distance reference.

In an embodiment, the sensor circuit issues the control signal to make an icon of the operation menu deform when the cursor is controlled to stay on the icon and the control object moves toward the capacitive touch panel, and the sensor circuit enables the touch device to perform a function corresponding to the icon if the determined distance value of the control object is smaller than a specific value or a specific proportion of the distance reference.

Another aspect of the present disclosure provides a floating touch device. The floating touch device includes a capacitive touch panel and a sensor circuit electrically connected to the capacitive touch panel. The sensor circuit controls the capacitive touch panel to sense a control object within different sensing ranges at different time points to detect a press action, and issue a control signal corresponding to the press action.

In an embodiment, the sensor circuit issues the control signal when the control object moves toward the capacitive touch panel and a distance value between the control object and the capacitive touch panel is smaller than a specific value or a specific proportion of a distance reference.

In an embodiment, the floating touch device includes an elastic cover disposed on the capacitive touch panel. A distance value between a touch area of the elastic cover and the capacitive touch panel before the press action is recorded as the distance reference.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1 is a schematic diagram illustrating a touch device according to an embodiment of the present invention;

FIGS. 2A-2C are schematic diagrams illustrating relations between sensing ranges and grouping electrode units;

FIG. 3 is a flowchart illustrating a floating touch method according to an embodiment of the present invention;

FIG. 4 is a flowchart illustrating a floating touch method according to another embodiment of the present invention;

FIG. 5A is a schematic diagram illustrating a floating touch action;

FIG. 5B is a schematic diagram illustrating an icon change in response to a press action;

FIG. 5C is a schematic diagram illustrating another floating touch action; and

FIG. 6 is a flowchart illustrating a floating touch method according to a further embodiment of the present invention; and

FIG. 7 is a schematic diagram illustrating a portion of a keyboard device operated with the float touching method according to the present disclosure.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

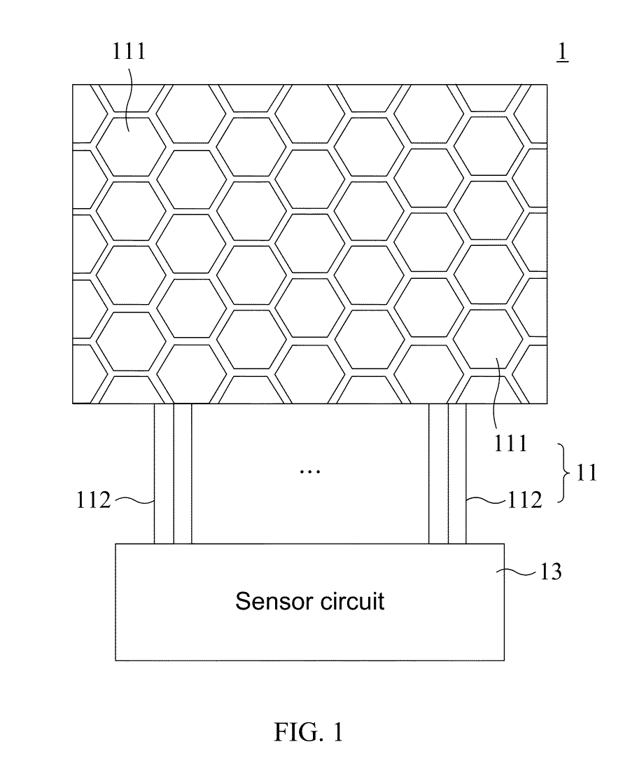

Please refer to FIG. 1, a schematic diagram illustrating a touch device according to an embodiment of the present invention. The touch device 1 includes a capacitive touch panel 11 and a sensor circuit 13. The capacitive touch panel 11 includes separate electrode units 111 and connecting traces 112. Each of the connecting traces 112 is electrically connected to a corresponding electrode unit 111 in one-to-one manner. In this embodiment, the electrode units 11 are (regular) hexagonal electrode units 11 but are not limited to this shape. The connecting traces 112 are electrically connected to respective electrode units 111, and the sensor circuit 13 is electrically connected to the connecting traces 112 so as to control the capacitive touch panel 11. The sensor circuit 13 controls the capacitive touch panel 11 to determine a distance value between a control object (e.g. a human finger, palm or conductive member) and the capacitive touch panel 11. The sensor circuit 13 controls the capacitive touch panel 11 to detect a floating touch action of the control object based on the distance value, and issues a control signal to enable the touch device 1 or the capacitive touch panel 11 to perform a specific function in response to the floating touch action of the control object.

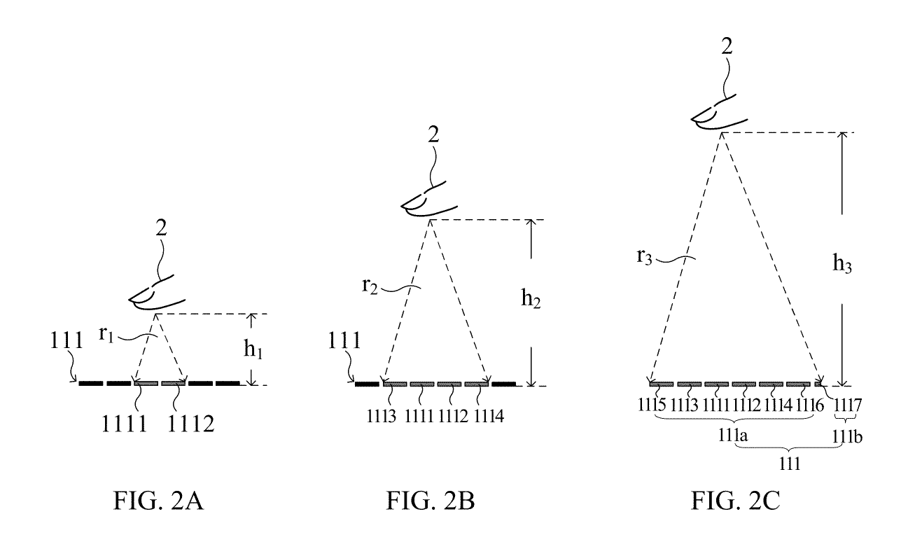

Please refer to FIGS. 2A-2C, schematic diagrams illustrating relations between sensing ranges and grouping electrode units. As shown in FIG. 2A, when the sensor circuit 13 simultaneously measures capacitances (or capacitance changes) of two electrode units 1111 and 1112, namely an electrode unit group, the control object 2 such as a finger located within the sensing range r₁ can be sensed according to floating touch technology. For many electrode unit groups each of which includes two electrode units 111, a combined sensing range with a “thickness” h₁ forms in front of the capacitive touch panel 11. In other words, if the control object 2 is located at a distance no more than a distance threshold h₁, the control object 2 can be sensed by the capacitive touch panel 11 when every two electrode units 111 are grouped to perform the sensing function. As shown in FIG. 2B, when the capacitances (or capacitance changes) of the electrode unit group including four electrode units 1111, 1112, 1113 and 1114 are measured, the control object 2 located within the sensing range r₂ which is greater than the sensing range r₁ can be sensed. Under this condition, a combined sensing range with a distance threshold h₂ is obtained. As shown in FIG. 2C, when the sensor circuits 13 simultaneously detects seven electrode units 1111, 1112, 1113, 1114, 1115, 1116 and 1117 which means that an electrode unit group includes seven electrode units, a further greater sensing range r₃ is achieved. Under this condition, the distance threshold is h₃.

Referring to FIGS. 2A-2C, the sensing range for floating touch can be adjusted by changing the number of the electrode units 111 in one electrode unit group, i.e. the number of the electrode units 111 simultaneously detected by the sensor circuit 13. In other words, the greater distance between the control object 2 and the capacitive touch panel 11 is, the larger virtual projected region covering the electrode units 111 is. The electrode units 111 included in the projected region are required for sensing the control object 2 at the specific distance. Thus, more electrode units 111 included in a greater projected region corresponds to a greater sensing range. Therefore, an effective area of the electrode units 111 included in the projected region results in an increased sensible distance between the control object 2 and the capacitive touch panel 11, and the effective area may be viewed as a parameter of sensing strength. It is possible to fine-tune or balance the effective area of the electrode units 111 included in an electrode unit group (projected region). As shown in FIG. 2C, the electrode units 1111, 1112, 1113, 1114, 1115, 1116 are full electrode units 111a, and the electrode unit 1117 is a fractal electrode unit 111b with a smaller electrode area. The fractal electrode units 111b may be arranged at specific regions of the capacitive touch panel 11, for example, around edges of the full electrode units 111a to adjust, balance or fine-tune the effective areas of the electrode unit groups. The quantities and the positions of the fractal electrode units 111b and the full electrode units 111a are not limited to this example and may be modified in different embodiments to meet various requirements.

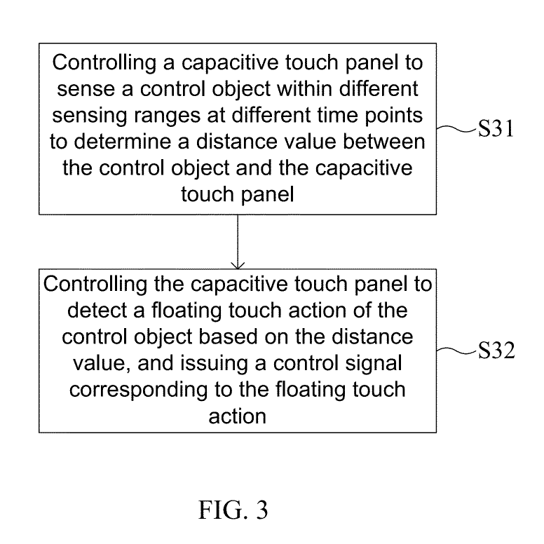

Please refer to FIG. 3, a flowchart illustrating a floating touch method according to an embodiment of the present invention. The floating touch method is used with a touch device 1 including a capacitive touch panel 11 and a sensor circuit 13. At first, the sensor circuit 13 controls the capacitive touch panel 11 to sense a control object 2 within different sensing ranges at different time points to determine a distance value between the control object 2 and the capacitive touch panel 11 (step S31). Then, the sensor circuit 13 controls the capacitive touch panel 11 to detect a floating touch action of the control object 2 based on the distance value, and issues a control signal to enable the touch device 1 or the capacitive touch panel 11 to perform a specific function in response to the floating touch action of the control object 2 (step S32). The distance value between the control object 2 and the capacitive touch panel 11 may be determined through different ways which are described in detail later.

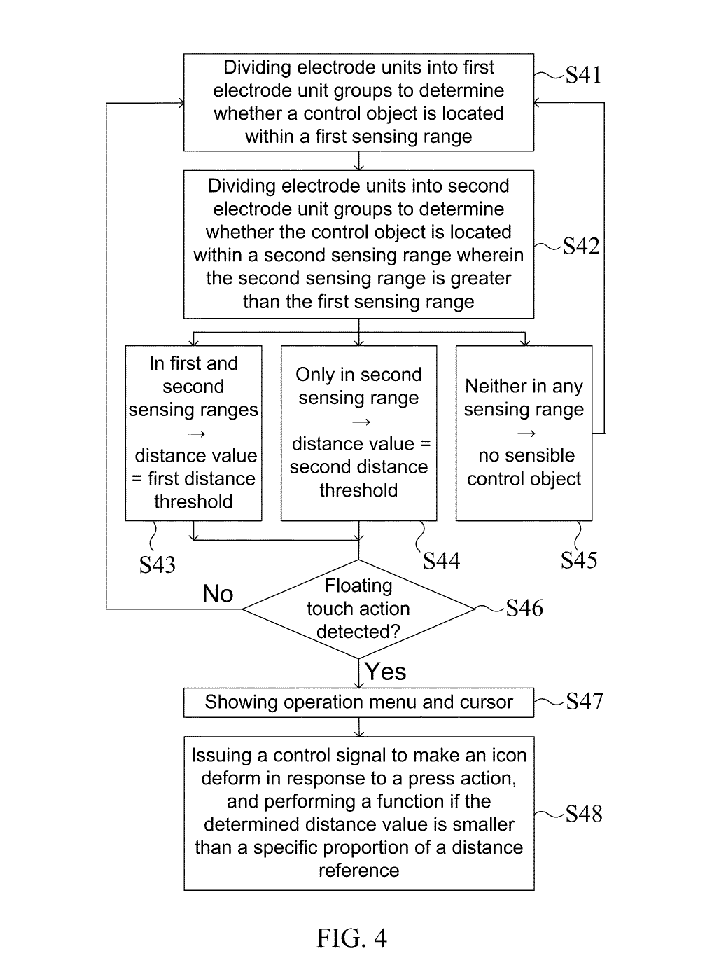

Please refer to FIG. 4, a flowchart illustrating a floating touch method according to another embodiment of the present invention. At first, the sensor circuit 13 divides the electrode units 111 into first electrode unit groups and detects the first electrode unit groups individually, and determines whether the control object 2 is located within a first sensing range corresponding to the first electrode unit groups (step S41). Each of the first electrode unit groups includes a first number of the electrode units 111. The sensor circuit 13 detects the electrode units 111 (i.e. measuring capacitances or capacitance changes of the electrode units 111) of the same first electrode unit group simultaneously in response to a first driving signal from the sensor circuit 13. Thus, the sensor circuit 13 can determine whether the control object 2 is located within the first sensing range according to the capacitance changes.

Then, the sensor circuit 13 divides the electrode units 111 into second electrode unit groups and detects the second electrode unit groups individually, and determines whether the control object 2 is located within a second sensing range corresponding to the second electrode unit groups (step S42). Each of the second electrode unit groups includes a second number of the electrode units 111, while the second number is greater than the first number. For example, one of the first electrode unit groups includes two electrode units 1111 and 1112 (FIG. 2A) and one of the second electrode unit groups includes four electrode units 1111, 1112, 1113 and 1114 (FIG. 2B). The second sensing range r₂ is greater than the first sensing range r₁. In a similar manner, the sensor circuit 13 detects the electrode units 111 (i.e. measuring capacitances or capacitance changes of the electrode units 111) of the same second electrode unit group simultaneously in response to a second driving signal from the sensor circuit 13. Thus, the sensor circuit 13 can determine whether the control object 2 is located within the second sensing range according to the capacitance changes. In this embodiment, the sensor circuit 13 controls the capacitive touch panel 11 to scan from a smaller sensing range to a larger sensing range, i.e. in a direction away from the touch device 1 like an outward scanning.

According to the determination in steps S41 and S42, the distance value between the control object 2 and the capacitive touch panel 11 is determined according to the following steps. If the control object 2 is determined to be located within both the first sensing range and the second sensing range, the distance value is a first distance threshold corresponding to the first sensing range (step S43). If the control object 2 is determined to be located within the second sensing range but not located within the first sensing range, the distance value is a second distance threshold corresponding to the second sensing range (step S44). If the control object 2 is determined to be not located within any of the first sensing range and the second sensing range (step S45), there is no sensible control object, and the method returns to step S41 to start another dividing and determining step.

Please be noted that the number of the sensing ranges may be adjusted according to the total quantity of the electrode units 111, dimension of the capacitive touch panel 11 or other factors. Therefore, the electrode units 111 are grouped in different sizes at different time points. On condition that the control object 2 is determined to be located within multiple sensing ranges, the distance value is the distance threshold corresponding to the smallest sensing range among the multiple sensing ranges.

The steps for determining the distance value are not limited to the examples as described above. For example, once the control object 2 is found to be located in a specific sensing range, it is not necessary for the sensor circuit 13 to control the capacitive touch panel 11 to scan farther. Therefore, the step for determining the distance value may be modified as follows. At first, the sensor circuit 13 divides the electrode units 111 into electrode unit groups and detects the electrode unit groups individually, and determines whether the control object 2 is located within a sensing range corresponding to the electrode unit groups. If the control object 2 is determined to be located within the sensing range, the distance value of the control object 2 is a distance threshold corresponding to the sensing range. If the control object 2 is determined to be not located within the sensing range, the sensor circuit 13 repeats the previous steps wherein the next electrode unit groups include more electrode units than the previous electrode unit groups. In this embodiment, the sensor circuit 13 does not control the capacitive touch panel 11 to complete a full scanning in a direction away from the touch device 1 every time to determine the distance value.

Alternatively, the sensor circuit 13 may control the capacitive touch panel to complete a full scanning in a direction away from the touch device 1 every time to determine the distance value. This approach can avoid unpredictable disturbance during the scanning.

As described above, the sensor circuit 13 controls the capacitive touch panel 11 to sense the control object 2 within different sensing ranges at different time points. The whole procedure may be considered as a three dimensional scanning action (i.e. x-axis and y-axis representing orthogonal directions along the surface of the capacitive touch panel 11 and z-axis representing a direction perpendicular to the surface). In addition to the position of the control object 2, the sensor circuit 13 can obtain more information such as motion or contours of the control object 2 in front of the touch device 1.

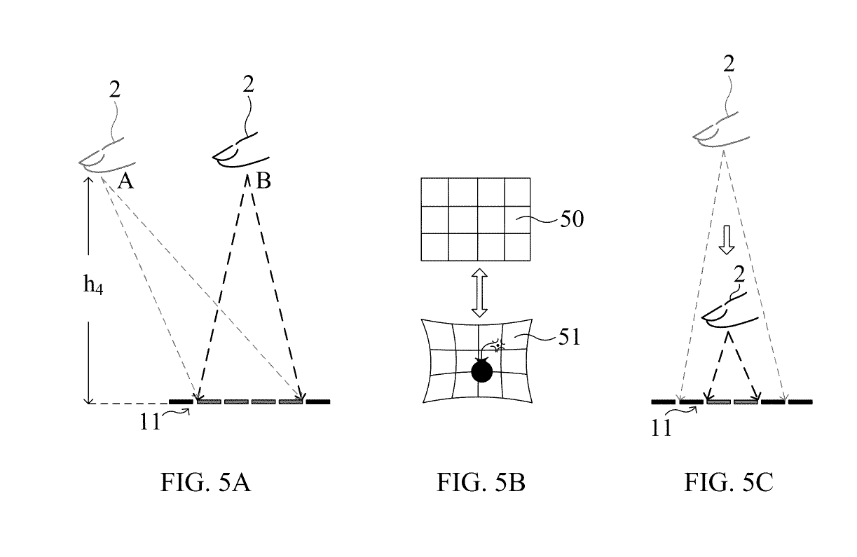

After the sensor circuit 13 determines the distance value between the control object 2 and the capacitive touch panel 11, the sensor circuit 13 controls the capacitive touch panel 11 to detect whether the control object 2 performs a floating touch action based on the determined distance value (step S46). For example, the floating touch action is a hover action, i.e. moving along a direction substantially parallel to the xy plane of the capacitive touch panel 11. As shown in FIG. 5A, the control object 2 moves from a position A to a position B at a distance h₄ from the capacitive touch panel 11, and the hover action can be detected by the sensor circuit 13 through sensing different electrode unit groups corresponding to the positions A and B.

If no floating touch action is detected in step S46, the method returns to step S41. Otherwise, if the sensor circuit 13 detects a floating touch action based on the distance value, the distance value h₄ is recorded as a distance reference. In addition, the sensor circuit 13 enables a display device (not shown) to show an operation menu and a cursor (step S47). The cursor moves or changes in response to subsequent movement of the control object 2.

Sometimes, the distance values determined during the hover action are not a constant value and slightly vary. Under this condition, the distance reference may be an average value of the determined distance values.

When the control object 2 stops moving and makes the cursor stay on an option or an icon 50 (FIG. 5B) of the operation menu, the control object 2 may be controlled to move toward the capacitive touch panel 11 to simulate a press action. Under this condition, the determined distance value between the control object 2 and the capacitive touch panel 11 becomes smaller and smaller (FIG. 5C). The press action can be detected by the sensor circuit 13 because smaller and smaller distance values are obtained during the press action. When the sensor circuit 13 finds the phenomenon during continuous scanning along the z-axis with respect to the capacitive touch panel 11, it is determined that a press action occurs. In response to the press action, the sensor circuit 13 issues a control signal to make the icon 50 deform. For example, the icon 51 curves inward continuously as shown in FIG. 5B, but it is not limited to such effect. During the press action, after the determined distance value is smaller than a specific value or a specific proportion (e.g. 50%) of the distance reference h₄, animation effects to the icon 51, e.g. rupture may be provided. Then, the touch device 1 performs a specific function represented by the icon 50 (step S48).

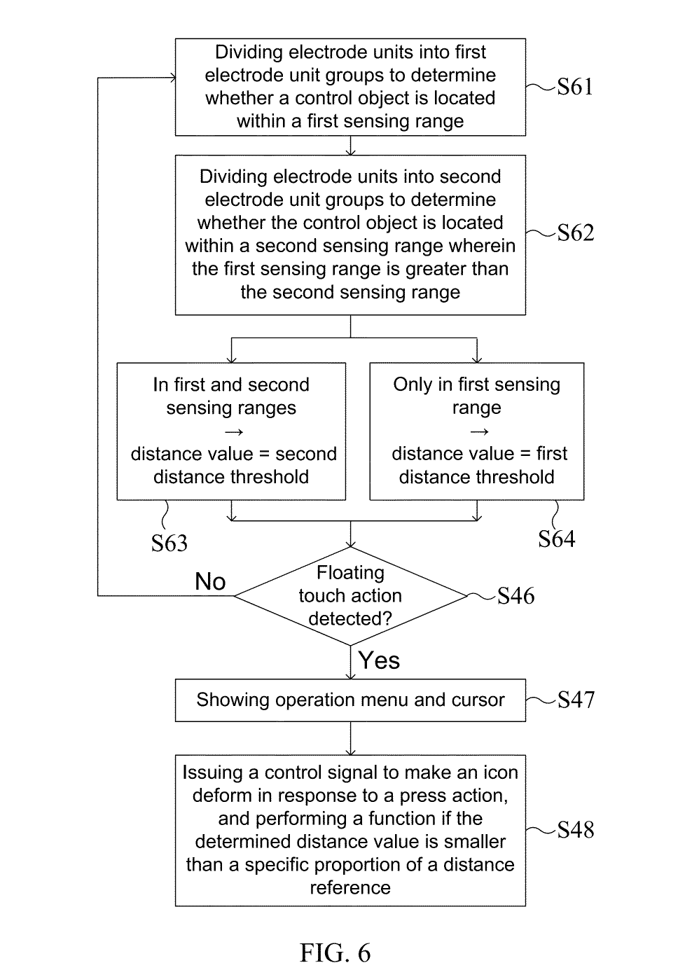

Please refer to FIG. 6, a flowchart illustrating a floating touch method according to a further embodiment of the present invention. Compared to the floating touch method with reference to FIG. 4, the floating touch method in this embodiment performs an inward scanning. At first, the sensor circuit 13 divides the electrode units 111 into first electrode unit groups and detects the first electrode unit groups individually, and determines whether the control object 2 is located within a first sensing range corresponding to the first electrode unit groups (step S61). Each of the first electrode unit groups includes a first number of the electrode units 111. The sensor circuit 13 detects the electrode units 111 (i.e. measuring capacitances or capacitance changes of the electrode units 111) of the same first electrode unit group simultaneously in response to a first driving signal from the sensor circuit 13. Thus, the sensor circuit 13 can determine whether the control object 2 is located within the first sensing range according to the capacitance changes.

Then, the sensor circuit 13 divides the electrode units 111 into second electrode unit groups and detects the second electrode unit groups individually, and determines whether the control object 2 is located within a second sensing range corresponding to the second electrode unit groups (step S62). Each of the second electrode unit groups includes a second number of the electrode units 111, while the first number is greater than the second number. For example, one of the first electrode unit groups includes four electrode units 1111, 1112, 1113 and 1114 (FIG. 2B) and one of the second electrode unit groups includes two electrode units 1111 and 1112 (FIG. 2A). The first sensing range r₁ is greater than the second sensing range r₂. In a similar manner, the sensor circuit 13 detects the electrode units 111 (i.e. measuring capacitances or capacitance changes of the electrode units 111) of the same second electrode unit group simultaneously in response to a second driving signal from the sensor circuit 13. Thus, the sensor circuit 13 can determine whether the control object 2 is located within the second sensing range according to the capacitance changes. In this embodiment, the sensor circuit 13 controls the capacitive touch panel 11 to scan from a larger sensing range to a smaller sensing range, i.e. in a direction toward the touch device 1 like an inward scanning.

According to the determination in steps S61 and S62, the distance value between the control object 2 and the capacitive touch panel 11 is determined according to the following steps. If the control object 2 is determined to be located within both the first sensing range and the second sensing range, the distance value is a second distance threshold corresponding to the second sensing range (step S63). If the control object 2 is determined to be located within the first sensing range but not located within the second sensing range, the distance value is a first distance threshold corresponding to the first sensing range (step S64). Furthermore, the sensor circuit 13 may control the capacitive touch panel 11 to finish a full inward scanning to accurately determine the distance value.

Please be noted that the number of the sensing ranges may be adjusted according to the total quantity of the electrode units 111, dimension of the capacitive touch panel 11 or other factors. Therefore, the electrode units 111 are grouped in different sizes at different time points. On condition that the control object 2 is determined to be located within multiple sensing ranges, the distance value is the distance threshold corresponding to the smallest sensing range among the multiple sensing ranges.

After the sensor circuit 13 determines the distance value between the control object 2 and the capacitive touch panel 11, steps S46-S48 are performed as described in the previous embodiment with reference to FIG. 4, and the redundant detail is not repeated here.

In conclusion, the floating touch method and the touch device operated with this method allow the capacitive touch panel 11 to sense a control object 2 within different sensing ranges at different time points. The major step is to divide the electrode units 111 into electrode unit groups to enlarge the sensible distance. The electrode units 111 in the same group are detected simultaneously in response to a driving signal. The driving signal may be sent to the electrode unit groups individually or simultaneously. Changing grouping size of the electrode units can adjust the sensing range to obtain a distance value. The sensor circuit 13 issues a control signal in response to a floating touch action of the control object 2 which is detected based on the distance value. The touch device 1 or the capacitive touch panel 11 performs the specific function in response to the control signal. Although the user may use the control object 2, i.e. his finger at different positions or different distances in front of the touch device 1, the distance values are obtained in real time to adapt the floating touch method for the user habit. It is not necessary for the user to stand at a fixed position to remotely control the touch device 1, so convenience and flexibility of the touch sensing operation is greatly improved.

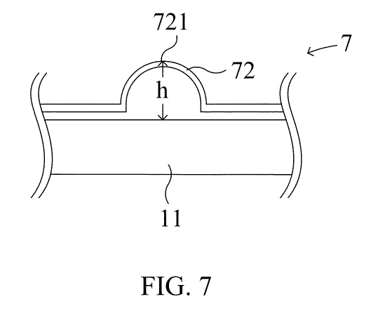

Further, the floating touch method and the touch device can be applied to an input device or other floating touch device, e.g. a keyboard device or a virtual keyboard. Please refer to FIG. 7, a schematic diagram illustrating a portion of a keyboard device operated with the float touching method according to the present disclosure. The keyboard device 7 includes a capacitive touch panel 11 and a sensor circuit (not shown), which are similar to the elements as described in the previous embodiments and the redundant detail is not repeated here. An elastic cover 72 is disposed on the capacitive touch panel 11. For example, the elastic cover 72 includes many arched or convex resilient member made of flexible or rubber material. Each convex resilient member may correspond to one key of the keyboard device 7. No electronic circuit is required to be connected to the elastic cover 72 because the elastic cover 72 mainly provides “touch and press feeling” assisting the user in accurate typing to reduce discomforts due to unfamiliar floating touch manner. The elastic cover 72 may be or may be not in contact with the capacitance touch panel 11. Before the user presses the elastic cover 72 with any control object such as a finger or palm, a distance h between a touch area 721 of the convex resilient member and the capacitive touch panel 11 may be considered as a distance reference as described above, but the distance reference is not limited to this definition.

When the user touches and presses the touch area 721 of a convex resilient member corresponding to a specific key, the sensor circuit can detect the press action by continuous scanning which includes the step of sensing the control object within different sensing ranges at different time points to determine distance values between the user finger and the capacitive touch panel 11. If the sensor circuit finds that the distance values are getting smaller and smaller, a press action may occur and the convex resilient member curves inward. After the distance value is smaller than a specific value or a specific proportion of the distance reference, e.g. 50%, the sensor circuit issues a keystroke signal (control signal) corresponding to the specific key of the keyboard device 7. After the pressure is removed from the touch area 721, the convex resilient member restores to its original shape. The elastic cover 72 may be fixed in the keyboard device 7, or be detachably coupled to the capacitive touch panel 11, especially for a virtual keyboard which is hidden for some cases. Alternatively, no elastic cover 72 is provided, and the user operates the keyboard device 7 in a floating manner.

In an embodiment, different distance references may be set for different regions on the touch device. For example, a display region and a keyboard region may have different distance references so as to adjust touch sensitivities for different regions. For another example, since the user may virtual-press the touch device with a non-constant pressure, e.g. greater pressure at the central region and weaker pressure at the sides, the sensing ranges and distance references may be adjusted at different regions to fit individual habit. Therefore, the present disclosure provides a more convenient and user friendly floating touch method and device.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A floating touch method used with a capacitive touch panel, comprising steps of:
controlling the capacitive touch panel to sense a control object within different sensing ranges at different time points to determine a distance value between the control object and the capacitive touch panel;
controlling the capacitive touch panel to detect a floating touch action of the control object based on the distance value; and
issuing a control signal corresponding to the floating touch action.

2. The floating touch method according to claim 1, wherein the capacitive touch panel comprises a plurality of separate electrode units and the step of controlling the capacitive touch panel to sense the control object comprises steps of:
dividing the electrode units into a plurality of first electrode unit groups, detecting the first electrode unit groups individually, and determining whether the control object is located within a first sensing range corresponding to the first electrode unit groups;
dividing the electrode units into a plurality of second electrode unit groups, detecting the second electrode unit groups individually, and determining whether the control object is located within a second sensing range corresponding to the second electrode unit groups; and
determining the distance value to be a distance threshold corresponding to a smaller sensing range of the first sensing range and the second sensing range if the control object is determined to be located within both the first sensing range and the second sensing range.

3. The floating touch method according to claim 2, wherein each of the first electrode unit groups has a first number of the electrode units while each of the second electrode unit groups has a second number of the electrode units, the second number being greater than the first number, the second sensing range being greater than the first sensing range.

4. The floating touch method according to claim 3, wherein when the control object is determined to be located within the first sensing range, the distance value is the distance threshold corresponding to the first sensing range.

5. The floating touch method according to claim 1, further comprising a step of showing an operation menu and a cursor in response to a floating touch action of the control object.

6. The floating touch method according to claim 5, wherein the floating touch action of the control object is a hover action and the distance value determined during the hover action is recorded as a distance reference.

7. The floating touch method according to claim 6, further comprising a step of issuing the control signal to make an icon of the operation menu deform when the cursor is controlled to stay on the icon and the control object moves toward the capacitive touch panel.

8. The floating touch method according to claim 7, further comprising a step of performing a function corresponding to the icon if the determined distance value of the control object is smaller than a specific value or a specific proportion of the distance reference.

9. A touch device operated with a floating touch method, comprising:
a capacitive touch panel; and
a sensor circuit electrically connected to the capacitive touch panel, configured to control the capacitive touch panel to sense a control object within different sensing ranges at different time points to determine a distance value between the control object and the capacitive touch panel, configured to control the capacitive touch panel to detect a floating touch action of the control object based on the distance value, and configured to issue a control signal corresponding to the floating touch action.

10. The touch device according to claim 9, wherein the capacitive touch panel comprises:
a plurality of separate electrode units; and
a plurality of connecting traces, each of which is electrically connected to a corresponding one of the electrode units.

11. The touch device according to claim 10, wherein the capacitive touch panel comprises a plurality of fractal electrode units disposed around edges of at least one of the separate electrode units.

12. The touch device according to claim 10, wherein the sensor circuit divides the electrode units into a plurality of first electrode unit groups which are detected individually to determine whether the control object is located within a first sensing range corresponding to the first electrode unit groups, divides the electrode units into a plurality of second electrode unit groups which are detected individually to determine whether the control object is located within a second sensing range corresponding to the second electrode unit groups, and determines the distance value to be a distance threshold corresponding to a smaller sensing range of the first sensing range and the second sensing range if the control object is determined to be located within both the first sensing range and the second sensing range.

13. The touch device according to claim 9, wherein the sensor circuit shows an operation menu and a cursor on a display device.

14. The touch device according to claim 13, wherein the floating touch action of the control object is a hover action and the distance value determined during the hover action is recorded as a distance reference.

15. The touch device according to claim 14, wherein the sensor circuit issues the control signal to make an icon of the operation menu deform when the cursor is controlled to stay on the icon and the control object moves toward the capacitive touch panel, and the sensor circuit enables the touch device to perform a function corresponding to the icon if the determined distance value of the control object is smaller than a specific value or a specific proportion of the distance reference.

16. A floating touch device, comprising:
a capacitive touch panel; and
a sensor circuit electrically connected to the capacitive touch panel, configured to control the capacitive touch panel to sense a control object within different sensing ranges at different time points to detect a press action, and issue a control signal corresponding to the press action.

17. The floating touch device according to claim 16, wherein the sensor circuit issues the control signal when the control object moves toward the capacitive touch panel and a distance value between the control object and the capacitive touch panel is smaller than a specific value or a specific proportion of a distance reference.

18. The floating touch device according to claim 17, further comprising an elastic cover disposed on the capacitive touch panel, a distance value between a touch area of the elastic cover and the capacitive touch panel before the press action being recorded as the distance reference.
